(19) United States
(12) Patent Application Publication
(10) Pub. No.: US 2021/0330063 A1
(43) Pub. Date: Oct. 28, 2021

(54) CARRYING BELT FOR CARRYING A VIDEO CAMERA OR STILL CAMERA ON THE BODY

(71) Applicant: Wolfgang-Peter GELLER, Garlstorf am Walde (DE)

(72) Inventor: Wolfgang-Peter GELLER, Garlstorf am Walde (DE)

(21) Appl. No.: 16/476,353

(22) PCT Filed: Jan. 5, 2018
(86) PCT No.: PCT/EP2018/050230

§ 371 Date: Jul. 8, 2019

(30) Foreign Application Priority Data
Jan. 9, 2017 (DE) 20 2017 100 051.6

(51) Int. Cl. A45F 5/00; A45F 3/12; A45F 3/14; G03B 17/56

(52) U.S. Cl. CPC A45F 5/00; A45F 3/12; A45F 2003/003; G03B 17/561; A45F 3/14

(57) ABSTRACT

A carrying belt for carrying a video camera or still camera on the body having a shoulder pad, a belt coupled to the shoulder pad that runs transversely across the upper body of a user, and at least one connecting piece for fastening the belt to the video or still camera. The belt includes a slide via which the belt is coupled to the shoulder pad so that the belt is movable in the direction of a longitudinal extension of the belt relative to the shoulder pad and is simultaneously secured to the shoulder pad transversely to the longitudinal extension. This solution is a development of a known carrying belt by allowing attachment of a still or video camera to the belt at the fittings provided for attaching a classical neck strap or to one of these fittings and a tripod belt bush on a camera.

### TECHNICAL FIELD

The invention relates to a carrying belt for carrying a video camera or still camera, having the features of a shoulder pad, a belt coupled to the shoulder pad which can be run transversely across the upper body of a user, and at least one connecting piece for fastening the belt to the video camera or still camera to be carried.

### BACKGROUND

### Background Information

Carrying belts have been known for a long time in the prior art. Thus, camera carrying belts for carrying still cameras or video cameras exist, which typically are delivered in a simple design as accessory of such cameras. By means of these carrying belts which have been known for a long time, still cameras or video cameras are worn in front of the chest of the user, wherein the carrying belt is passed around the neck and hung there (thus forming a “neck strap”).

As an alternative to the classical carrying belts to be passed around the neck, carrying belts designed for still cameras or video cameras have also recently become known in which the belts are worn transversely over the upper body of the user, starting from a shoulder down to approximately hip level, where the carried still camera or video camera to which the carrying belt is connected is hung and positioned laterally on the body. In such carrying belts, the connecting piece is guided slidably on the belt, so that the still camera or video camera can be guided upward from a carried position laterally on the hip of the user until it is in front of the face in a shooting position, wherein the connecting piece slides along the belt during this movement.

Such a carrying belt to be placed transversely over the upper body is disclosed in WO 2008/131135 A1, for example. The carrying belt disclosed therein presents different possibilities of connection of the connecting piece to the still camera or video camera. The multiple connection possibilities here use a tripod threaded bush on the bottom of the camera, into which an adapter screw is screwed, which is connected or will be connected with the connecting piece guided slidingly on the belt. This type of fastening is also conventional for currently commercially available carrying belts of this kind. In WO 2008/131135 A1 (see FIG. 24), an additional connection possibility is also shown, in which short supplemental belts are arranged on the connecting piece, on the ends of which connecting elements are formed for the connection with the fastening elements arranged typically laterally on the top of the camera housing for the “classical” camera belt to be worn around the neck. However, in practice, the solution shown there is not suitable since, when the camera is raised in front of the face, the short supplemental belts hang down after the weight has been removed and are then either located on the back side of the camera in front of the view finder and interfere with the operation of the camera or else they hang down on the front side of the camera in front of the lens and prevent shooting. Accordingly, in practice, a solution of this kind has also never been implemented.

In principle—especially in the case of heavy cameras such as, for example, single-lens reflex cameras, in particular those with lenses of higher focal length—the carrying belts to be worn transversely over the upper body are highly esteemed by the users, since, on the one hand, in this type of carrying, the weight loading the carrying belt rests on a shoulder and is thus carried more conveniently than when it weighs on the neck. On the other hand, the position of the camera carried laterally with respect to the hip is commonly also perceived to be less interfering than the carrying position of a camera carried on the “classical” camera carrying belt in front of the chest.

Although many users know and appreciate the above-described advantages of the carrying belt of known type which is worn transversely over the upper body, the complaint is commonly made that the camera has to be fastened to the carrying belt via a screw connection with the tripod threaded bush. Many users do not trust such a screw connection, in particular since the tripod threaded bush is precisely not designed by the camera manufacturers for a strong tensile load which it is exposed to in the connection with the known carrying belt, but is instead designed for loads on a screwed-in tripod, at most for transverse loads, when the camera is mounted swiveled on the tripod by 90°. In addition, some users also have concerns with regard to the safety of the screw connection between an adapter screw, present on the known carrying belt to be worn transversely over the upper body, and the tripod threaded bush. Here, some interested parties fear that the screw connection could possibly come undone and that the valuable camera fastened to the carrying belt could fall to the ground and be damaged.

### SUMMARY

The aim of the present invention is to further develop a known carrying belt to be worn over the upper body, as disclosed in particular in WO 2008/131135 A1, to the effect that said carrying belt enables attachment of a still camera or a video camera to be fastened thereto on at least one of the devices of such a camera, which are provided for attaching a classical neck belt, while at the same time enabling a simple and unhindered handling and operation of the camera to be attached to the carrying belt.

This aim is achieved according to the invention with a carrying belt having a shoulder pad, a belt coupled to the shoulder pad, which can be run transversely across the upper body of a user, and at least one connecting piece for fastening the belt to the video camera or still camera to be carried and characterized by a slide via which the belt is coupled to the shoulder pad in such a way that the belt can be moved in the direction of a longitudinal extension of the belt relative to the shoulder pad and is simultaneously secured to the shoulder pad transversely to the longitudinal extension. Advantageous developments of such a carrying belt according to the invention are that the carrying belt has two longitudinal ends, on each of which a connecting piece for attachment to the video camera or still camera to be carried is arranged. One of the connecting pieces is a tripod screw for screwing into a tripod threaded bush provided on the video camera or still camera. The shoulder pad has a cushioning. The carrying belt includes a securing belt which is connected to the shoulder pad and which, when in use, can be run under a shoulder on which the shoulder pad rests and can be closed to form a closed loop. The carrying belt includes a slide in the form of at least two retaining loops attached to the shoulder pad, through which loops the belt is threaded. The carrying belt may include a slide in the form of at least one sliding casing formed on the shoulder pad, through which the belt is fed. The carrying belt includes multiple pairs of claw-like elements opposite one another transversely to the longitudinal direction, which are arranged one after the other in the longitudinal direction of the shoulder pad along a longitudinal direction of the belt and arranged in a guided manner in the slide, and which retain the belt arranged in the slide, wherein, between the claw-like elements of each pair in each case a gap is left for the insertion of the belt into the slide. The claw-like elements are arranged firmly on the shoulder pad and connected to the latter, wherein the claw-like elements consist of a material which has less flexibility than the material of the rest of the shoulder pad. The slide has a longitudinal groove introduced into the shoulder pad, in which the belt is arranged in a guided manner and over which the claw-like elements extend. The carrying belt includes at least one securing element placed over the belt and attached to the shoulder pad. The securing element is detachably attached to the shoulder pad. The carrying belt includes protection against severing provided on the belt in the form of a reinforcement led in the longitudinal direction of the belt, in particular in the form of a metal wire or metal rope or a strand made of poly(p-phenylene terephthalamide) (PPTA), an ultra-high molecular weight polyethylene (UHMW-PE) or another cut-resistant material.

According to the invention, a carrying belt for carrying a video camera or still camera to begin with has the following three elements: a shoulder pad, a belt coupled to the shoulder pad, which can be passed transversely over an upper body of a user, and at least one connecting piece for fastening the belt to the camera to be carried. The novelty and essential feature for the invention here then consists in that the carrying belt comprises a slide via which the belt is coupled to the shoulder pad in such a manner that the belt can be moved in a direction of a longitudinal extension of the belt relative to the shoulder pad and is simultaneously secured the shoulder pad transversely to the longitudinal extension.

By means of this novel and inventive design, it can be achieved that a connecting piece for attaching the belt to a photo camera (still camera) or a video camera to be carried can be connected firmly to the belt, that is to say it is not designed as an adapter which slides over the belt. Indeed, during the raising from the carrying position, which in the inventive carrying belt as in the prior art will be lateral approximately at hip level of the user, into a position of use of the camera in front of the face of the user, the connecting piece then no longer has to be moved relative to the belt, but instead the entire belt is shifted relative to the shoulder pad which remains stationary. This is made possible by the slide equipped according to the invention via which the belt is coupled to the shoulder pad. Due to this design, for example, for a connection of the carrying belt to the connecting structures of the still camera or video camera to be carried, which are routinely provided by the manufacturer for attaching a neck belt, it is no longer necessary, as in in WO 2008/131135 A1, to provide a short supplemental belt which is attached to the adapter piece sliding on the carrying belt and which, in the position of use, as described above, hangs down in an interfering manner behind or in front of the camera. Instead, the belt can be attached directly to the camera using at least one of the connecting structures, so that, in the position of use of the camera, the belt, which then has a longer total length as also in the case conventional neck belts, hangs down to the side of said camera, without preventing the use of a still camera or a video camera carried in this manner. Here, the inventive carrying belt is at the same time easy to produce and also easily and conveniently handled by a user. It combines the advantages of the carrying comfort of the previously known carrying belts passed over the upper body with the possibility of a safe fastening of the video camera or still camera to be carried to at least one of the structures provided by the manufacturer for fastening neck belts, in combination with an interference-free use of the camera as in the case of a neck belt.

Even though other fastening possibilities in connection with the inventive carrying belt are possible in principle, it is preferable for the belt to comprise two longitudinal ends on which in each case a connecting piece for the attachment to the camera to be carried is arranged. To that extent, the belt can in principle be provided with two connecting pieces for attachment to the belt connections provided on the camera for attaching a standard neck belt and thus can be designed like a typical neck belt which is provided in the same way with such connecting pieces wherein the belt of the inventive carrying belt is naturally longer than a typical neck belt since it needs to reach transversely over the upper body of a user. Here, such a connecting piece should be understood quite generally. It can in particular be a connecting ring like a snap ring or key ring, a karabiner or else simply a structure whereby the belt end can be led through an eyelet and the belt end can be folded down and attached to itself, for example, with a connecting site in the manner of a belt buckle or the like. Here, the belt can be connected relatively firmly to the camera in a classical attachment of the neck belts delivered as camera accessory.

A variant of the invention here provides that only one of the connecting pieces is formed on the belt for the connection with one of the belt connections of the camera and that the other connecting piece has the form of a tripod screw. In such a variant, the belt is connected by a first end with one of the typical belt connections of the camera, is screwed by a second end into a tripod threaded bush arranged on the camera, typically on a housing bottom, by means of the connecting piece designed in the form of a tripod screw, and is thus connected to the camera. In particular in cameras with long and heavy lenses, this variant results in a particularly good carrying comfort, since the camera fastened in this manner and worn over the head hangs on the side of the body on the carrying belt and in the process can cling to the body of the user. In this position, the camera carried in this manner also has a clearly reduced tendency to undergo a pendulum movement when the user is walking.

Instead of a firm connection as described above in the variants shown, the connecting pieces can also be designed so that the belt can be simply detached from the camera, for example, by hooking or plugging into one or two adapter pieces. In such a design, the belt and thus the carrying belt can be separated quickly from the camera if necessary. For this purpose, for example, a conventional plug-in system can be used. However, a plug-in system designed in particular for this purpose can also be used, which also has additional safety features, for example, a doubly secured plug-in system. The use of an adapter system, whether this be for plugging or another type of connection, moreover has the advantage that, in such an adapter, shock absorbing elements (so-called “shock absorbers”) can be integrated, by which, for example, in the case of heavy cameras attached to the carrying belt, for example cameras with long focal length lenses, the acceleration and deceleration forces during walking and running can be absorbed or at least reduced.

For the implementation of shock absorption, the belt itself can here be designed to be resilient in general. A shock absorbing element, designed as an accessory or a component of the belt, can achieve its action with the following means and action principles: a permanently elastic band such as a rubber band for example, a porous elastic material such as a foam for example, air or oil dampers or spring elements. Furthermore, the repelling or attracting effect of two or more magnets can be used for the implementation of shock absorption.

In order to increase the carrying comfort of the carrying belt according to the invention, the shoulder pad can advantageously comprise a cushioning.

For the comfort of use of the inventive carrying belt, it is essential that the shoulder pad does not slide during use but instead rests on the shoulder, even when the belt is shifted through the slide. In order to further secure the position of the shoulder pad, the carrying belt according to the invention can advantageously comprise a securing belt which is connected to the shoulder pad and which during use can be led through under the shoulder on which the shoulder pad rests and closed to form a closed loop. Such a securing belt can be formed, for example, by two belt ends firmly connected for example, sewn or riveted, to the shoulder pad, which in each case can be connected to one another, for example, via snap-in or clip connections as used, for example, for chin straps of bicycle helmets or the like. In particular, the length of the securing belt can be adjustable here, so that it can be adapted individually to the user and his/her anatomy.

The slide can consist, for example, of at least two retaining straps which are attached to the shoulder pad and through which the belt is threaded. Alternatively, the slide can also be in the form of a sliding casing formed on the shoulder pad through which the belt is fed.

In an additional design variant, the slide can comprise pairs of claw-like elements opposite one another transversely to the longitudinal direction, which are arranged one after the other along a longitudinal direction of the belt arranged in a guided manner in the slide, which retain the belt arranged in the slide in the slide, wherein, between the claw-like elements of each pair in each case a gap is left for the insertion of the belt into the slide. Such a variant of the shoulder pad of an inventive carrying belt enables, on the one hand, a simple production of the shoulder pad and, on the other hand, an easy mounting of the belt in the shoulder pad. In particular, when, as can be provided according to a variant of this embodiment, the claw-like elements are arranged firmly on the shoulder pad and connected to the latter, and the claw-like elements here consist of a material which has less flexibility than the material of the rest of the shoulder pad, it is possible, for the mounting of the belt on the shoulder pad, to bend down the shoulder pad along a line oriented in the direction of the slide, so that the claw-like elements are spread apart, and the gaps formed between the respective pairs of the mutually facing claw-like elements open up. In such a state, the belt can be simply inserted from above into the slide. After the shoulder pad is bent back or reshaped, the gaps close again due to the elasticity of the material, and the claw-like elements retain the belt securely in the slide and prevent a raising of the belt from the shoulder pad.

When, as provided in an additional design variant of this embodiment, a longitudinal groove is introduced into the shoulder pad, in which the belt is arranged in a guided manner, wherein this longitudinal groove is part of the slide and the claw-like elements extend over the longitudinal groove, a further improved arrangement and guiding of the movement exclusively in the longitudinal direction of the belt is achieved for the belt in the slide.

As a possible securing against unwanted detachment of the belt from the shoulder pad by unintended spreading of the claw-like elements, it can be provided that at least one securing element and optionally multiple securing elements are provided, which are placed over the belt and attached on the shoulder pad. This/These securing element(s) stretch(es) over the belt in such a manner that even in the case of a deformation of the shoulder pad, the belt cannot come out of the area of the securing element or of the securing elements. Naturally, the securing elements must not interfere with the movement of the belt in longitudinal direction in the slide. The securing element(s) here can here be attached, in particular detachably, to the shoulder pad, in order to make it possible for the belt to be detached from the shoulder pad, for example, for exchanging a shoulder pad or a belt in an inventive carrying belt.

Independently of the form of the slide, on the one hand, the belt, and, on the other hand, the slide itself, in particular with its surfaces in contact with the belt, will typically be designed in such a manner that the existing friction is so low that a reliable relative movement of the belt with respect to the slide is made possible for transferring the carried still camera or video camera from the carrying position into the position of use. However, enough friction should still exist here so that, in the carrying position, dangling movements of the carried camera caused during walking or running do not result in unwanted slippage of the belt relative to the slide, which would lead to a more extensive dangling or swiveling movements of the carried camera and thus to a reduction of the carrying comfort.

For an improvement of theft prevention, it can be provided that, on the belt, a protection against severing in the form of a reinforcement guided in longitudinal direction of the belt is provided. This reinforcement can in particular consist of a metal rope placed on the belt or embedded in the belt, or a metal wire of this kind or a strand of another cut-resistant material such as, for example, poly(p-phenylene terephthalamide) (PPTA)—a material sold under the name of “Kevlar”—, an ultra-high molecular weight polyethylene (UHMW-PE) such as, for example, a material of the brand Dyneema® from the Royal DSM N.V., Netherlands, which makes it impossible for the belt to be simply severed and for the valuable camera attached to it to be stolen. Alternatively, the entire belt (or only a section of the belt which is at particularly high risk of being attacked by cutting) can also be made of a cut-resistant material. A sheath made of a cut-resistant material, which is to be placed around the belt, can also be placed around the belt as a protection against severing.

### BRIEF DESCRIPTION OF THE SEVERAL VIEWS OF THE DRAWINGS

Additional advantages and features of the invention result from the following description of possible embodiment examples in reference to the appended figures. In the figures:

FIG. 1 shows a diagrammatic partial representation of a person who is carrying a still camera with an inventive carrying belt formed according to a first embodiment in a carrying position, from the front;

FIG. 2 shows a diagrammatic partial representation of the person shown in FIG. 1, from the back;

FIG. 3 shows a detailed representation of a shoulder pad of an inventive carrying belt in a first design variant;

FIG. 4 shows a detailed representation of a shoulder pad of an inventive carrying belt in a second alternative design variant;

FIG. 5 shows a diagrammatic partial representation of a person who is carrying a still camera with an inventive carrying belt formed according to an alternative embodiment in a carrying position, from the front;

FIG. 6 shows a diagrammatic partial representation of the person shown in FIG. 5 from the back;

FIG. 7 shows a detail representation of a shoulder pad of an inventive carrying belt formed according to the alternative embodiment shown in FIGS. 5 and 6,

FIG. 8 shows another view of the shoulder pad according to FIG. 7 with belt inserted in the slide,

FIG. 9 shows, in a view similar to FIG. 5, a diagrammatic representation of a person in a view from the front, said person carrying a still camera with a carrying belt which is formed in particular with regard to its connecting pieces according to another possible embodiment design variant, and

FIG. 10 shows a view of the person shown in FIG. 5 with the carrying belt of the embodiment shown there, from the back.

### DETAILED DESCRIPTION

In the figures, in highly diagrammatic representations, possible embodiments of an inventive carrying belt are shown. Here, it must be emphasized that the figures are neither true to scale nor technically correct in terms of details. Instead, they are used to illustrate the invention in possible design variants, wherein the figures also do not show, for example comprehensively, all the conceivable possible embodiments of the invention.

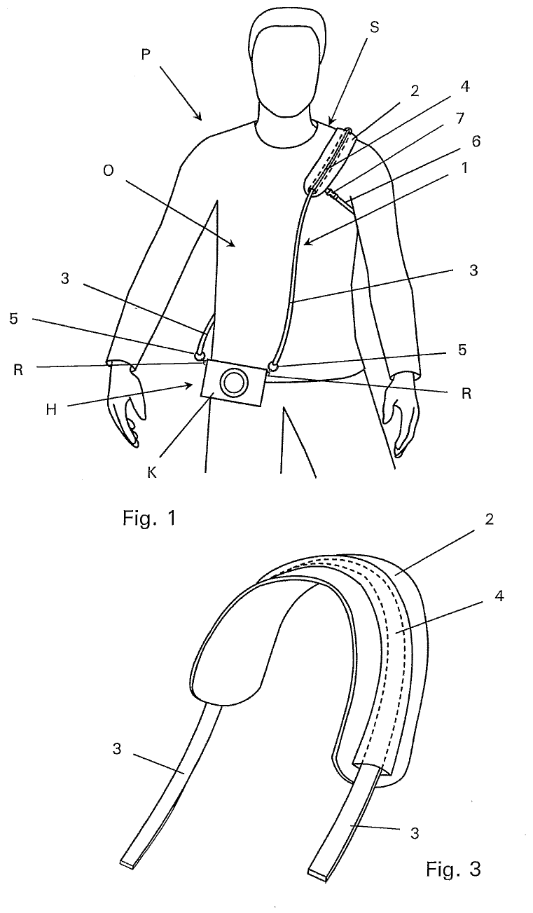

In FIG. 1, to be begin with, a person P is diagrammatically represented, wherein the representation here is limited largely to the upper body O of the person P, and said person P has put on an inventive carrying belt 1 and by means of said carrying belt carries a camera K (here a still camera) in a carrying position. In FIG. 1, this person P is shown represented in a view from the front. FIG. 2 shows the same person P with the inventive carrying belt 1 in a view from the back.

The inventive carrying belt 1 comprises a shoulder pad 2 which rests on a shoulder S, here the left shoulder, of the person P. The carrying belt 1 moreover has a belt 3 which is led through a slide 4 on the shoulder pad 2 and which comprises at two free ends in each case a connecting piece 5 for the connection with a belt connection R of the camera K. In the embodiment example shown, the connecting pieces 5 are formed in the form of rings like key rings. However, the shape of the connecting pieces 5 is not limited here to this form, for example. In particular, on the camera K, on the belt connections R, adapter pieces can be mounted, to which the free ends of the belt 3 are attached. Such adapter pieces can then contain, for example, shock absorbing elements or also receiving pockets for small objects to be carried along, such as, for example, data cards, filter inserts or cellphones or lipsticks. By means of the slide 4, the belt 3 is coupled to the shoulder pad 2, but cannot be detached from it during use. However, the slide 4 enables a relative movement of the belt 3 relative to the shoulder pad 2 in the longitudinal direction of the belt 3. Thereby, when the person P takes the camera K resting in the carrying position approximately at the level of the hip H of the person P and moves it into a position of use in front of the face, the belt 3, which is guided transversely over the upper body O relative to the shoulder pad 2 in the carrying position as shown in FIGS. 1 and 2, is shifted so that, in the position of use, the belt 3 hangs down loosely on both sides from the camera K and does not interfere.

In order to ensure that the shoulder pad 2 securely maintains its position on the shoulder S of the person P during the use of the carrying belt 1, in the design variant of an inventive carrying belt 1 shown in FIGS. 1 and 2, a securing belt 6 is provided, which is attached in the area of the two longitudinal ends of the elongate shoulder pad 2 and which can be connected by means of a latching buckle 7 to form a closed loop or which can be opened from the loop. The securing belt 6 here is ideally configured so as to be adjustable in length, so that it can be adjusted optimally by the person P using the carrying belt 1 tailored to his/her anatomical conditions. Here the securing belt 6 prevents in particular a shifting of the shoulder pad 2 relative to the shoulder S of the person P (or at least limits such shifting), when the camera K is moved and raised by the person P from the carrying position into the position of use, and, in the process, the belt 3 is shifted relative to the shoulder pad 2 through the slide 4.

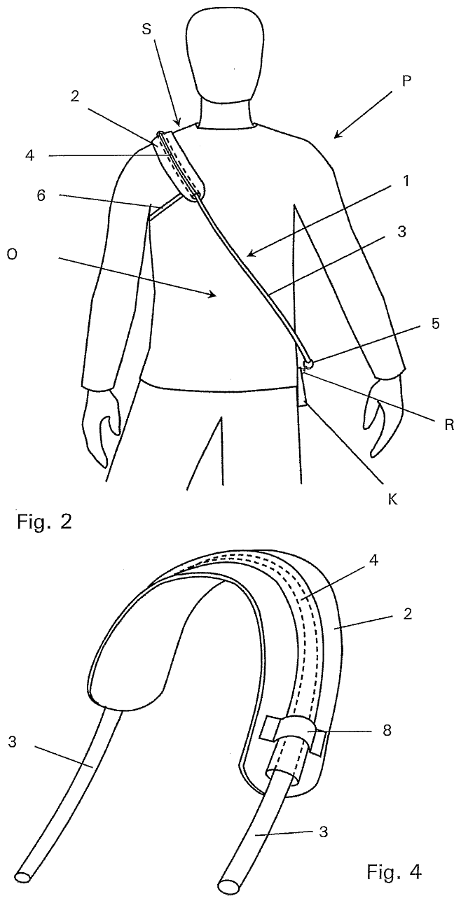

In FIGS. 3 and 4, two possible design variants of the belt 3 and of an associated slide 4 are shown. Here the slides 4 are each formed as a sliding casing, wherein the belt 3 shown in FIG. 3 is formed to be flat and with a substantially rectangular cross section, and the slide 4 designed as a sliding casing is accordingly also formed to be flat, wherein, in the embodiment example shown in FIG. 4, the belt 3 has an approximately circular cross section and accordingly the slide 4 formed as a sliding casing also has a circular cross section. In the embodiment example shown in FIG. 4, the slide 4 formed as a sliding casing and thus in the end also the belt 3 are additionally secured with retaining loops 8 against detachment from the shoulder pad 2. However, the shoulder pad 2 and the slide 4, in particular in the form of a sliding casing, can also be produced from one piece of material. This can occur, for example, by injection molding from a particularly elastic material. If necessary, a sliding casing can receive a tube-like insert which leaves sufficient play for the belt 3 for a free movement in its longitudinal direction.

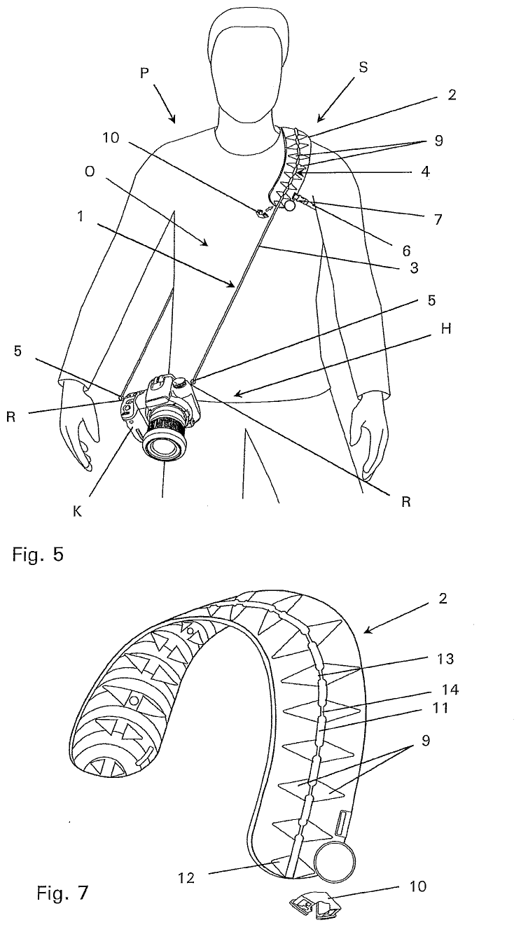

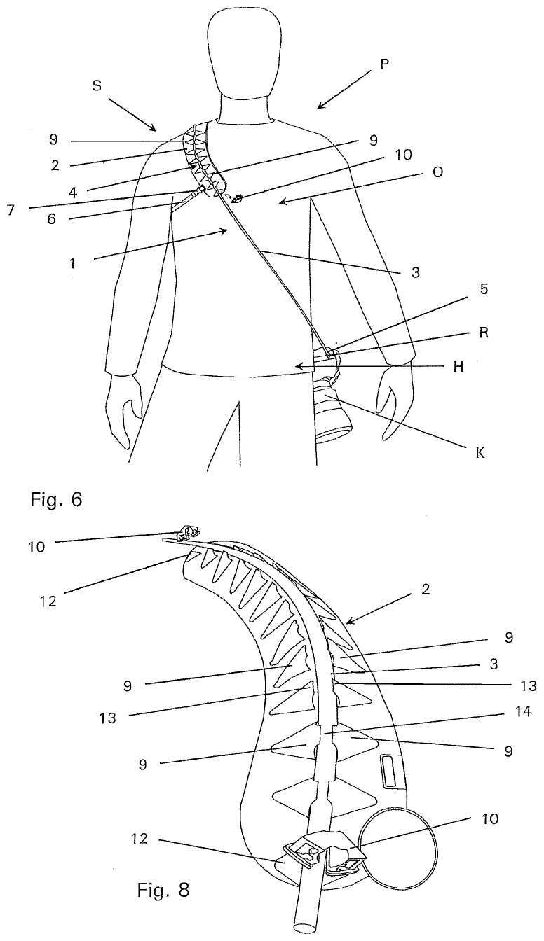

In FIGS. 5 to 8, an additional alternative embodiment example for a design of an inventive carrying belt 1 is shown. This carrying belt 1 is of identical implementation in terms of essential components and constructed like the carrying belt in the above-described embodiment examples. Here too, a shoulder pad 2 is provided, which is connected to a belt 3 which is attached to the shoulder pad in such a manner that it is guided in a slide 4 and can be moved relative to the shoulder pad 2. Here too, a securing belt 6 can be guided under the arm on the shoulder S of the person P using the carrying belt 1, for securing the shoulder pad 2 in its position on the shoulder S. By means of latching buckles 7, the securing belt 6 can be detachably connected to the shoulder pad 2, so that the carrying belt 1 can also be used without the securing belt 6. In particular, for this purpose, the securing belt 6 can also be offered as a separate accessory, as is the case also for the above-described embodiment examples. In the embodiment example described here, the belt 3 also has, on its free ends, connecting pieces 5 by means of which the belt 3 can be connected in a known manner to the belt connections R of a camera K, shown in FIGS. 5 and 6, here a single-lens reflex camera. The carrying position and the functioning of the carrying belt 1 are also identical to those according to the above-described embodiment examples, in particular the carrying belt 1 is here also worn transversely over the upper body O of the person P using the carrying belt 1, wherein the camera K rests at the level of the hip H of the person P in a carrying position. From here, the camera K can be gripped and raised into a position of use in front of the face of the person P using the carrying belt 1, wherein in the process the belt 3 is shifted relative to the shoulder pad 2 in the slide 4.

Compared to the above-described embodiments, the particular and distinguishing feature of the embodiment variant shown in FIGS. 5 to 8 then consists of the concrete design of the shoulder pad 2 with the slide 4. As in the above embodiment example, the shoulder pad 2 also comprises as base a shoulder cushion which consists of a flexible and resilient material which, on the one hand, brings about the desired cushioning properties and, on the other hand, enables a deformation of the shoulder pad 2 for the adaptation to the form of the shoulder S of the person P using the carrying belt 1. The material of this shoulder cushion can be, for example, a foam, a neoprene or the like. In the shoulder pad 2 according to the embodiment example described here, claw-like elements 9 are firmly connected to the shoulder cushion. These claw-like elements 9 extend in each case in pairs facing one another in a longitudinal direction of the slide 4, in which the belt 3 is mounted in such a manner that it can be shifted in its longitudinal direction in a guided manner. The claw-like elements 9 are here formed in particular by a material which is clearly less flexible than the material of the shoulder cushion of the shoulder pad 2, in particular a rigid material, for example, a plastic such as PE or PP. As can be seen in FIGS. 7 and 8, the claw-like elements 9 arranged in pairs in the longitudinal direction face one another in the respective pairs transversely to the longitudinal direction of the slide 4, and thus transversely to the direction of extension of the belt 3 in the slide 4 by means of protrusions 13 which leave a gap 14 between themselves. Here, the claw-like elements 9 with the protrusions 13 surround the belt 3, which is shown in this embodiment example with circular cross section, but which is not limited to this cross-sectional form and can also have a cross section of different form, for example partially rectangular or square, thus retaining the belt in the slide 4. Here, a longitudinal groove 11, located in the shoulder pad 2 and between the claw-like elements 9 of the respective pairs and extending in longitudinal direction of the shoulder pad 2 and the slide 4, is provided, which forms a portion of the slide 4 and in which the belt 3 is guided, with partial positive connection. In this manner, by the longitudinal groove 11 and the claw-like elements 9, in particular the protrusions 13 thereof, a type of sliding casing is formed through which the belt 3 can move in its longitudinal direction relative to the shoulder pad 2. The material of the upper side of the longitudinal groove 11 facing the belt 3 and the material of the claw-like elements 9, in particular in the sections in which the belt 3 is in contact with these claw-like elements 9, are in the interaction with the material of the belt 3 selected in such a manner that the result is a sufficiently low friction which allows a relative movement between belt 3 and shoulder pad 2 in the above-described manner. At the same time, a minimum friction action is set here, which, already during normal movements, for example when the person P is walking, prevents the belt 3 from moving through the slide 4 and thus prevents the carried camera K from dangling along the hip H of the person P in a kind of pendulum movement.

The above-described design of the shoulder pad 2 with claw-like elements 9, which are a substantial component of the slide 4 formed in this embodiment example, enables a simple insertion of the belt 3 into the slide 4. In particular, the circumstance that the shoulder cushion of the shoulder pad 2 comprises a relatively flexible material and the claw-like elements 9 are formed in a clearly more rigid manner in comparison thereto enables a spreading apart of the claw-like elements 9 by an opening buckling movement of the shoulder pad 2 along the longitudinal groove 11 which thus provides a kind of folding line here. Thereby, the claw-like elements 9 spread apart, as indicated in FIG. 8, so that the gaps 14 formed by the latter open and the belt 3 can be inserted into or removed from the slide 4. This enables not only a simple mounting of the carrying belt 1 but it also allows a replacement either of the belt 3 or of the shoulder pad 2 in an existing carrying belt 1.

In order to ensure that the belt 3 does not become accidentally detached from the shoulder pad 2 during use due to a deformation of the shoulder pad 2 and an associated spreading apart of the claw-like elements 9, in the embodiment example shown here, securing elements 10 are provided, which can be inserted and firmly clipped into latching recesses 12 in the shoulder pad 2 and which completely cover the belt 3 and thus secure the shoulder pad 2 from becoming detached transversely to the longitudinal direction of the belt 3. In the embodiment example shown, corresponding securing elements 10 are provided on the two longitudinal ends of the shoulder pad 2. In FIGS. 5 and 6, the securing elements 10 are shown detached from the shoulder pad 2, wherein it is indicated by an arrow that the securing elements 10 are inserted and clipped into the corresponding latching recesses 12 and thus attached. The securing elements 10 can here be detachably engaged on the shoulder pad 2 and attached in the latching recesses 12, in order to be make it possible to detach the belt 3 from the shoulder pad 2 and thus achieve the possibility, already described above, of a replacement of belt 3 and/or shoulder pad 2.

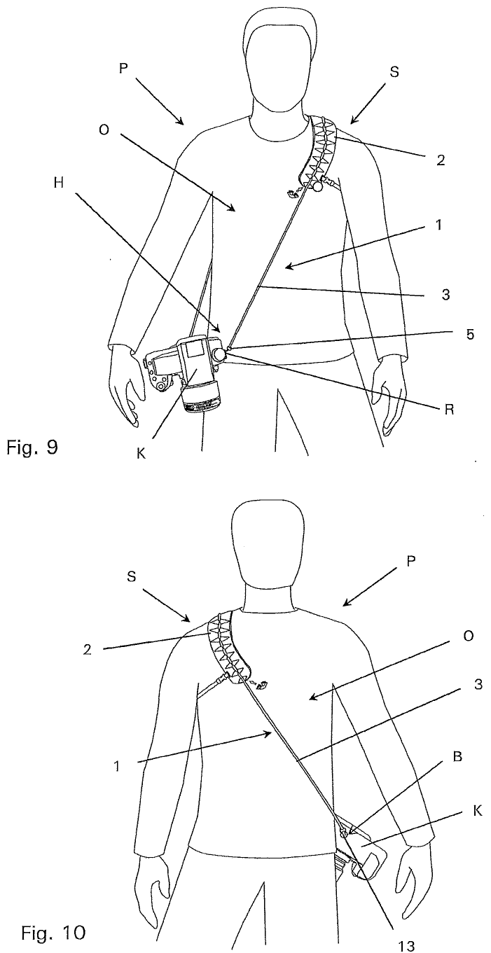

In FIGS. 9 and 10—therein with a variant of the design of the shoulder pad according to the embodiment variant described in FIGS. 5 to 8—a carrying belt with an alternative design of the connections to the camera K, which are formed on the ends of the belt 3, is represented. In the variant shown there, which can also be implemented with other designs of the shoulder pad, as shown in greater detail in FIGS. 3 and 4 for example, a connecting piece 5 for the connection to a belt connection R of the camera K is provided on a first end of the belt 3, and a tripod screw is fastened to a second end of the belt 3. In this design variant, by means of said tripod screw, the belt 3 of the carrying belt 1 is attached to a tripod threaded bush B of the camera as typically provided on a housing bottom of the camera, in that the tripod screw 15 is screwed into the tripod threaded bush B. In order to secure the tripod screw in the tripod threaded bush B, it is possible to provide securing means which are known from the prior art and therefore not described in further detail here.

In this variant, as can be seen in FIG. 9 for example, in particular in comparison to FIGS. 1 and 5, a camera K attached to the carrying belt 1 can be carried in another position, namely a position rotated over the head, on the side on the hip H. This ensures a particularly satisfactory carrying comfort, in particular in the case of cameras K with long lenses. Here too, the camera K hung and carried in this manner has a lower tendency to undergo pendulum movements.

Besides the differently detached fastening to the camera K with the correspondingly modified means, the connecting piece 5 and the tripod screw 15 on the ends of the belt 3, the carrying belt 1 shown in FIGS. 9 and 10 also works according to the above-described principle, and, in particular, the belt 3 is arranged on the shoulder pad in a longitudinally shiftable manner with respect to the shoulder pad 2.

In all the embodiment variants shown, the shoulder pad 2 can be provided with a cushioning in order to increase the carrying comfort. Here, the belt 3 can also be provided with a protection against severing, for example, in the form of a reinforcement with, for example, a metal wire or metal rope extending in longitudinal direction of the belt or with a strand made of poly(p-phenylene terephthalamide) (PPTA), for example a material available under the commercial name “Kevlar,” an ultra-high molecular weight polyethylene (UHMW-PE), for example a material of the brand Dyneema® from the Royal DSM N.V. or a similar cut-resistant material. Other measures besides those described above for including a protection against severing can also be used here.

The above-mentioned description of the embodiment example further clarifies the essential features and the advantageous properties of the inventive carrying belt 1.

### LIST OF REFERENCE NUMERALS

1 Carrying belt
2 Shoulder pad
3 Belt
4 Slide
5 Connecting piece
6 Securing belt
7 Latching buckle
8 Retaining loop
9 Claw-like element
10 Securing element
11 Longitudinal groove
12 Latching recess
13 Protrusion
14 Gap
15 Tripod screw
B Tripod threaded bush
H Hip
K Camera
O Upper body
P Person
R Belt connection
S Shoulder

1. A carrying belt for carrying a video camera or still camera on the body, having
a shoulder pad;
a belt coupled to the shoulder pad, and which runs transversely across the upper body of a user;
at least one connecting piece for fastening the belt to a video camera or a still camera to be carried,
a slide via which the belt is coupled to the shoulder pad in such a way that the belt is movable in a direction of a longitudinal extension of the belt relative to the shoulder pad and is simultaneously secured to the shoulder pad transversely to the longitudinal extension.

2. The carrying belt according to claim 1, wherein the belt has two longitudinal ends on each of which a connecting piece for attachment to the video camera or the still camera is arranged.

3. The carrying belt according to claim 2, wherein one of the connecting pieces is a tripod screw adapted to screw into a tripod threaded bush provided on the video camera or the still camera.

4. The carrying belt according to claim 1, wherein the shoulder pad has a cushioning.

5. The carrying belt according to claim 1, further comprising a securing belt which is connected to the shoulder pad and which, when in use, is adapted to run under a shoulder on which the shoulder pad rests and is closable to form a closed loop.

6. The carrying belt according to claim 1, wherein the slide in the form of at least two retaining loops attached to the shoulder pad, and through which loops the belt is threaded.

7. The carrying belt according to claim 1, wherein the slide is in the form of at least one sliding casing formed on the shoulder pad, through which the belt is fed.

8. The carrying belt according to claim 1, further comprising multiple pairs of claw-like elements opposite one another transversely to the longitudinal direction, wherein the multiple pairs of claw-like elements are arranged one after the other in a longitudinal direction of the shoulder pad along a longitudinal direction of the belt and arranged in a guided manner in the slide, wherein the multiple pairs of claw-like elements retain the belt arranged in the slide, and wherein a gap is left between the claw-like elements of each pair of claw-like elements and the gap is left for the insertion of the belt into the slide.

9. The carrying belt according to claim 8, wherein the multiple pairs of claw-like elements are arranged firmly on the shoulder pad and connected to the shoulder pad, and wherein the multiple pairs of claw-like elements are comprised of a material which has less flexibility than a material used in a rest of the shoulder pad.

10. The carrying belt according to claim 8 wherein the slide has a longitudinal groove introduced into the shoulder pad and in which the belt is arranged in a guided manner and over which the multiple pairs of claw-like elements extend.

11. The carrying belt according to claim 1, further comprising at least one securing element placed over the belt and attached to the shoulder pad.

12. The carrying belt according to claim 11, wherein the securing element is detachably attached to the shoulder pad.

13. The carrying belt according to claim 1, further comprising a protection against severing provided on the belt, wherein the protection is a reinforcement led in the longitudinal direction of the belt.

14. The carrying belt according to claim 13, wherein the reinforcement led is one or more of a metal wire, a metal rope, a strand made of poly(p-phenylene terephthalamide) (PPTA), an ultra-high molecular weight polyethylene (UHMW-PE), and another cut-resistant material.
